(19) United States
(12) Patent Application Publication
(10) Pub. No.: US 2013/0248665 A1
(43) Pub. Date: Sep. 26, 2013

(54) TELEVISION BASE AND TELEVISION SAFETY DEVICE

(71) Applicant: Peter Koklamanis, Kenosha, WI (US)

(72) Inventor: Peter Koklamanis, Kenosha, WI (US)

(21) Appl. No.: 13/429,317

(22) Filed: Mar. 24, 2012

(51) Int. Cl. H04N 5/00

(52) U.S. Cl. 248/206.3; 248/205.5

(57) ABSTRACT

A television base and a television safety device includes a suction cup attachment mechanism to help secure a television base and/or a television to a television stand. One or more suction cups may hold one or more bars, where the bars can secure the television base to the television stand. For example, a bar may extend between two suction cups. The bar may be disposed over the television base while the suction cups are secured to the television stand. Other designs are also possible, using one or more suction cups attached to one or more bars, to secure a television and prevent it from tipping.

### BACKGROUND OF THE INVENTION

The present invention relates to safety devices and, more particularly, to a television base safety device that helps secure a television base onto a television stand and or a television safety device that helps secure a television in its entirety onto a television stand.

Televisions fall on small children and cause injury or death because the base on large, flat screen televisions cannot withstand the top force once a television is tipped.

As can be seen, there is a need for an apparatus for securing a television base to help prevent a television from tipping.

### SUMMARY OF THE INVENTION

In one aspect of the present invention, a television safety device comprises first and second suction cups; and a connecting beam attached to the first suction cup at a first end thereof and attached to the second suction cup at a second end thereof, wherein the connecting beam is spaced from a surface onto which the suction cups attach by a distance equal to a thickness of a television support base.

In another aspect of the present invention, a television safety device comprises a suction cup adapted to attach to a surface; and an arm extending from the suction cup, the arm adapted to secure a television support base of a television resting on the surface.

In a further aspect of the present invention, a television safety device comprising a television support base having at least one suction cup formed therein, wherein the suction cup attaches to a surface when the television support base is disposed on the surface.

These and other features, aspects and advantages of the present invention will become better understood with reference to the following drawings, description and claims.

### BRIEF DESCRIPTION OF THE DRAWINGS

FIG. 1 is a perspective view of a television base safety device, in use, according to an exemplary embodiment of the present invention;

FIG. 2 is a perspective view of the television base safety device of FIG. 1, removed from the television base;

FIG. 3 is a perspective view of the television base safety device of FIG. 1;

FIG. 4 is a cross sectional view taken along line 4-4 of FIG. 3;

FIG. 5 is a perspective view of a television base safety device, in use, according to another exemplary embodiment of the present invention;

FIG. 6 is a perspective view of a television base safety device, in use, according to a further exemplary embodiment of the present invention;

FIG. 7 is a perspective view of a television base safety device, in use, according to still a further exemplary embodiment of the present invention;

FIG. 8 is a perspective view of a television base safety device, in use, according to a further exemplary embodiment of the present invention;

FIG. 9 is a cross-sectional view taken along line 8-8 of FIG. 8; and

FIG. 10 is a perspective view of a television base safety device, in use, according to a further exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a television safety device that includes a suction cup attachment mechanism to help secure a television to a television stand. One or more suction cups may hold one or more bars, where the bars can secure the television to the television stand. For example, a bar may extend between two suction cups. The bar may be disposed over the television base while the suction cups are secured to the television stand. Other designs are also possible, using one or more suction cups attached to one or more bars, to secure a television and prevent it from tipping.

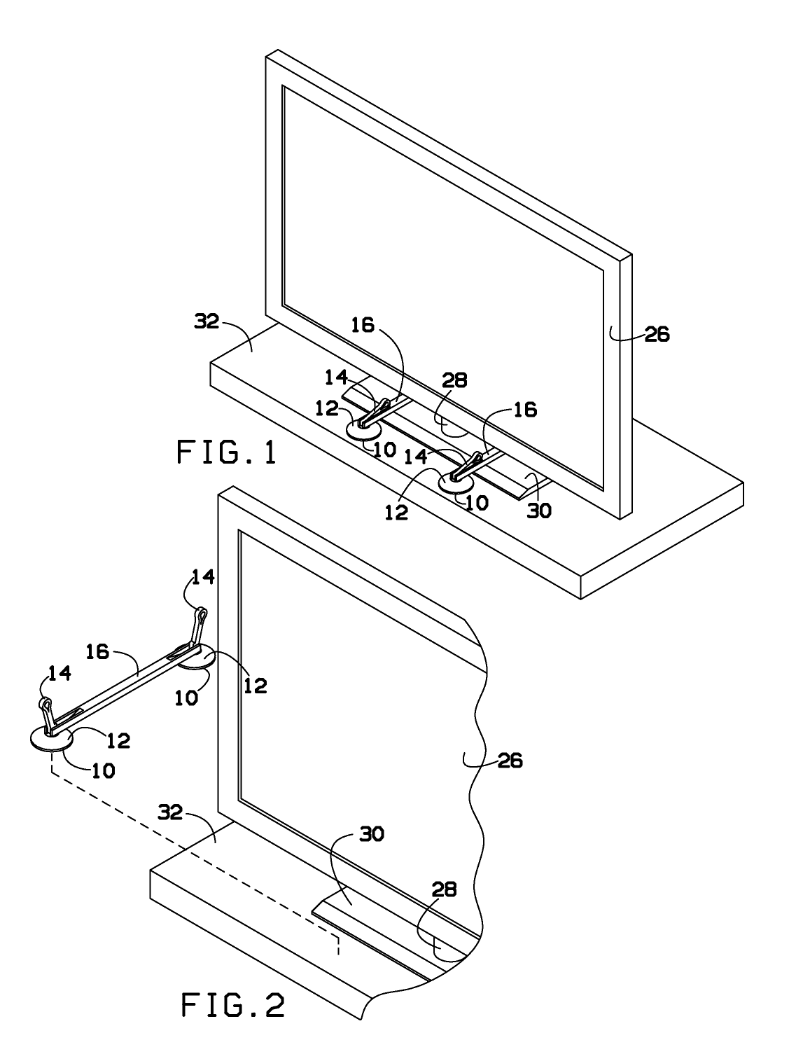

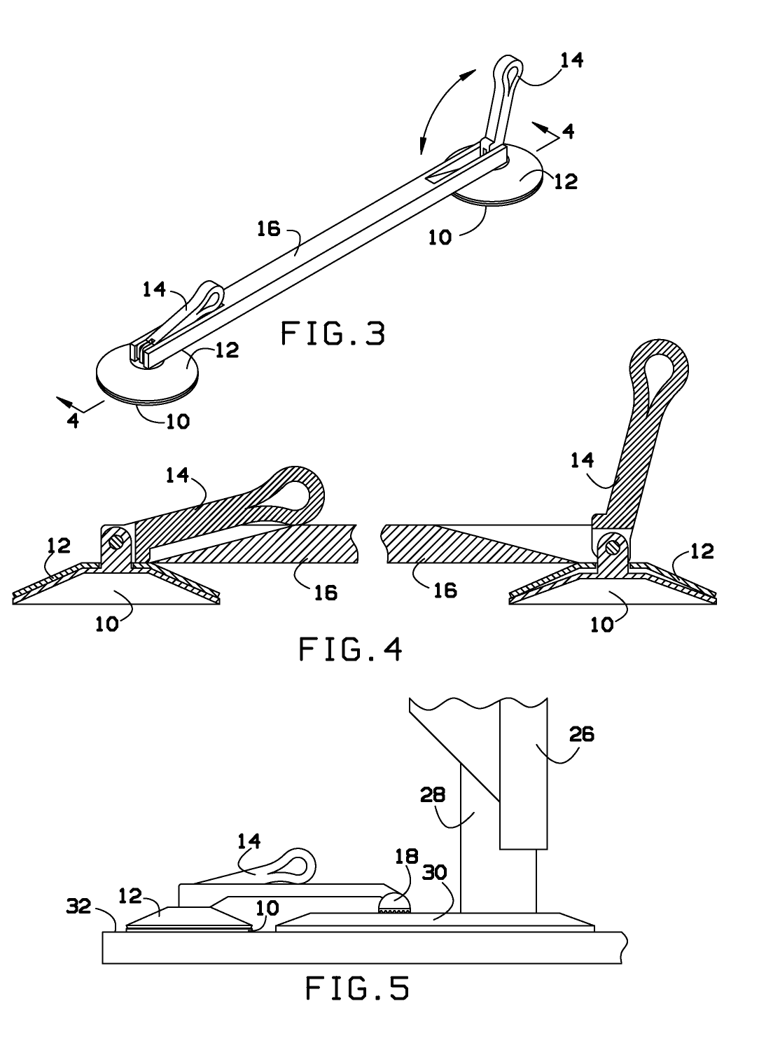

Referring to FIGS. 1 through 4, a suction cup 10 may be disposed on each end of a connecting beam 16. The suction cups 10 are adapted to be secured to a television stand 32 (or any smooth furniture top where the television is placed) while the connecting beam 16 extends across a television support base 30 that supports a television 26. The connecting beam 16 can hold the television support base 30 and prevent it from sliding or tipping. In some embodiments, the suction cups 10 may be disposed inside a rigid suction cup support cone 12. A locking suction cup actuating handle 14 may be used to help secure the suction cup 10 to the television stand 32.

While the drawings show the connecting beam 16 attached directly to the tops of the suction cups 10, in some embodiments, such as those where the television support base 30 is thick, the connecting beam 16 may turn at an angle on each end before connecting to the suction cups 10. This design may provide a greater distance between the television stand 32 and the bottom edge of the connecting beam 16.

Referring now to FIG. 5, in an alternate embodiment of the present invention, a single suction cup 10 may connect to a gripper 18, such as a rubber gripper. The gripper 18 may press against the television support base 30, typically on a back side of the television support base 30, to prevent movement and tipping thereof. In some embodiments, the gripper 18 may be rotatable, with a mechanism, such as a thumb screw (not shown) to fix the rotation at a given angle. This rotation may provide support for thicker or thinner television support bases 30.

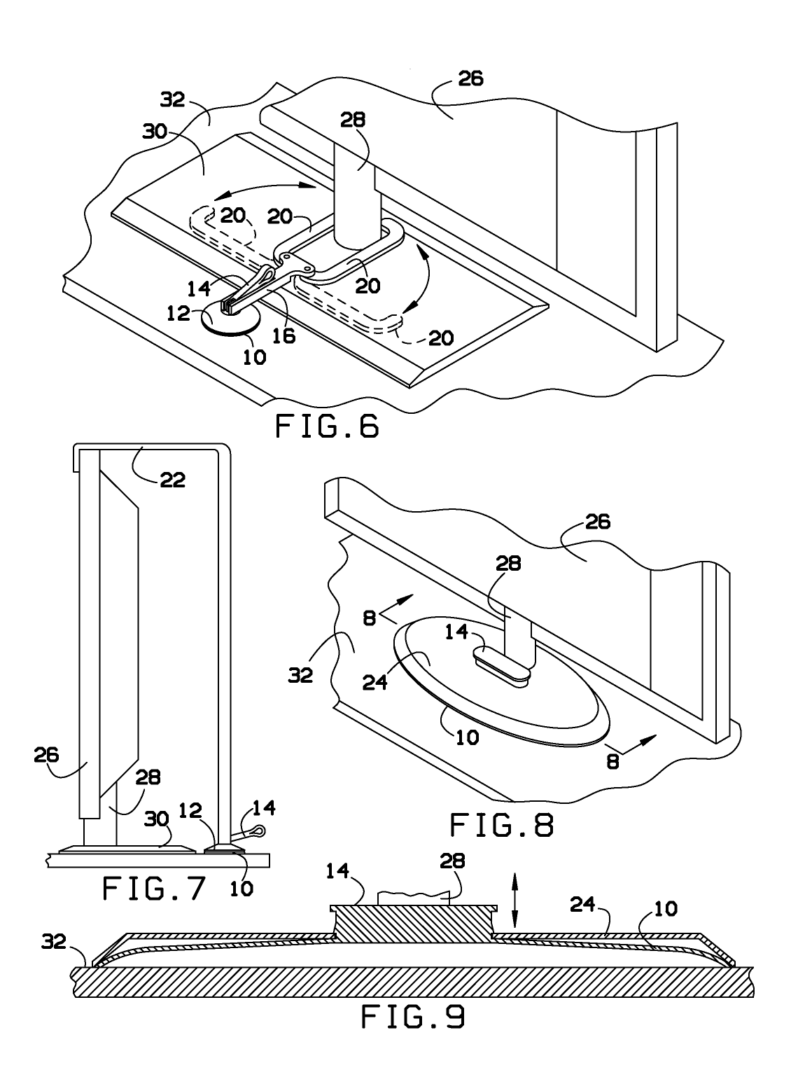

Referring now to FIG. 6, in an alternate embodiment of the present invention, a single suction cup 10 may support pivoting jaws 20 that may pivot on top of the television support base 30. In some embodiments, the pivoting jaws 20 may pivot about a television support column 28. In this embodiment, the pivoting jaws 20 may not only help prevent the television 26 from tipping, but may also prevent the television base stand 30 from sliding on the television stand 32.

Referring to FIG. 7, in another alternate embodiment of the present invention, a single suction cup 10 may retain an overhead stabilizer 22 that may reach around the top of the television 26 to help support the television 26 from tipping.

It should be noted that the above designs may be used alone or in combination. For example, the overhead stabilizer 22 of FIG. 7 could be used with the pivoting jaws 20 of FIG. 6 or the gripper 18 of FIG. 5, for example. In some embodiments, multiple support pieces may extend from a single suction cup. In other embodiments, multiple suction cups may be used for multiple support pieces.

Referring now to FIGS. 8 and 9, the television support base 30 described above may be replaced with a specially adapted suction cup base 24. The suction cup base 24 may include a large suction cup 10 formed in a bottom section thereof, designed to hold the suction cup base 24 to the television stand 32 when the base 24 is placed thereupon. A locking suction cup actuating handle 14 may be disposed on and extend from the suction cup base 24 to help in securing and removing the suction cup 10 to/from the television stand 32.

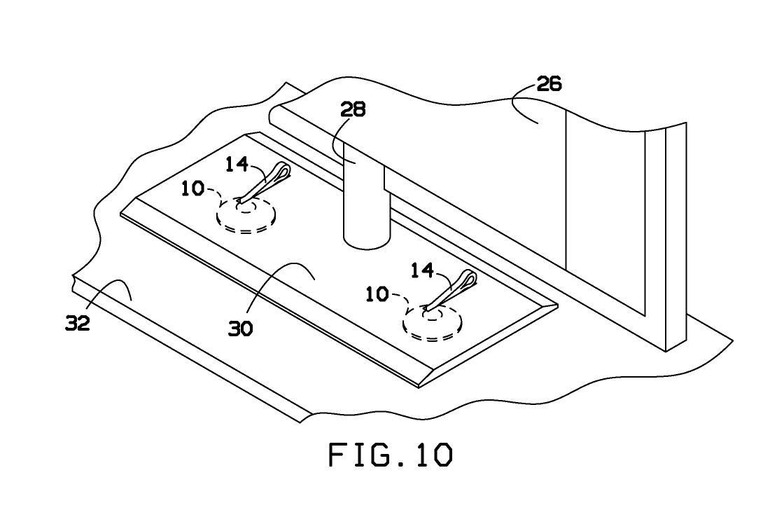

Referring to FIG. 10, in place of the single large suction cup described in FIGS. 8 and 9, a plurality of suction cups 10, such as two suction cups 10 may be disposed on each side of the television support base 30. The locking suction cup actuating handles 14 for each suction cup 10 may extend from the top of the television support base 30 to help in securing and removing the suction cup 10 to/from the television stand 32.

In some embodiments of the present invention, a locking mechanism (not shown) may be provided to help keep the locking suction cup actuating handle 14 in a locked position. Such a locking mechanism may help prevent a child form accidentally or deliberately unlocking the suction cup 10.

It should be understood, of course, that the foregoing relates to exemplary embodiments of the invention and that modifications may be made without departing from the spirit and scope of the invention as set forth in the following claims.

What is claimed is:

1. A television safety device comprising:
first and second suction cups; and
a connecting beam attached to the first suction cup at a first end thereof and attached to the second suction cup at a second end thereof, wherein
the connecting beam is spaced from a surface onto which the suction cups attach by a distance equal to a thickness of a television support base.

2. The television safety device of claim 1, further comprising a rigid suction cup support cone disposed over the first and second suction cups.

3. The television safety device of claim 1, further comprising a locking suction cup actuating handle disposed on the first and second suction cups.

4. A television safety device comprising:
a suction cup adapted to attach to a surface; and
an arm extending from the suction cup, the arm adapted to secure a television support base of a television resting on the surface.

5. The television safety device of claim 4, wherein the arm is a gripper adapted to apply pressure to and grip the television support base.

6. The television safety device of claim 4, wherein the arm includes pivoting jaws adapted to extend about a television support column above the television support base.

7. The television safety device of claim 4, wherein the arm is an overhead stabilizer adapted to fit over and around a top portion of the television.

8. The television safety device of claim 4, further comprising:
a rigid suction cup support cone disposed over the first and second suction cups; and
a locking suction cup actuating handle disposed on the first and second suction cups.

9. A television safety device comprising a television support base having at least one suction cup formed therein, wherein the suction cup attaches to a surface when the television support base is disposed on the surface.

10. The television safety device of claim 9, further comprising a locking suction cup actuating handle extending from a top of the television support base.
